(19) United States
(12) Patent Application Publication
(10) Pub. No.: US 2009/0145880 A1
(43) Pub. Date: Jun. 11, 2009

(54) LIQUID JET-GUIDED ETCHING METHOD FOR REMOVING MATERIAL FROM SOLIDS AND ALSO USE THEREOF

(76) Inventors: Kuno Mayer, Freiburg (DE); Bernd O. Kolbesen, Bad Homberg (DE)

Correspondence Address: GAUTHIER & CONNORS, LLP, 225 FRANKLIN STREET, SUITE 2300, BOSTON, MA, 02110, US

(21) Appl. No.: 12/346,113

(22) Filed: Dec. 30, 2008

Related U.S. Application Data
(63) Continuation of application No. PCT/EP2007/005846, filed on Jul. 2, 2007.

(30) Foreign Application Priority Data
Jul. 3, 2006 (DE) 102006030588.4

(51) Int. Cl. B44C 1/22

(52) U.S. Cl. 216/53

(57) ABSTRACT

The present invention relates to a method for removing material from solids by liquid jet-guided etching. The method according to the invention is used in particular for cutting, microstructuring, doping of wafers or also the metallisation thereof.

### PRIORITY INFORMATION

The present application is a continuation of PCT Application Ser. No. PCT/EP2007/005846 filed on Jul. 2, 2007, that claims priority to German Application No. DE 1020060300588.4, filed on Jul. 3, 2006. Both applications are incorporated herein by reference in their entireties.

### BACKGROUND OF THE INVENTION

The present invention relates to a method for removing material from solids by liquid jet-guided etching. The method according to the invention is used in particular for cutting, microstructuring, doping of wafers or the metallisation thereof.

Various methods are already known from the state of the art in which, with the help of a liquid jet-guided laser, silicon or other materials are etched or removed by ablation. For example, EP 0 762 974 B1 describes a liquid jet-guided laser, water being used here as liquid medium. The water jet serves here as conducting medium for the laser beam and as coolant for the edges of the machined places on the substrate, the aim of reducing damage by thermal stress in the material being pursued. With liquid jet-guided lasers, deeper and somewhat cleaner cut grooves are achieved than with “dry” lasers. Also the problem of constant refocusing of the laser beam with increasing groove depth is achieved with lasers coupled into the liquid jet. However lateral damage still occurs in the described systems to the extent that a further material removal from the machined surfaces is required, which makes both the entire process of material machining complex and also leads to additional material loss and hence increased costs.

The standard microstructuring processes which operate on the basis of photolithographically defined etching masks with respect to precision and lateral damage have to date been superior to laser-assisted methods but are much more complex and significantly slower than the latter.

The attempts in this respect have however been restricted exclusively to surface machining of the substrates. Deep cuts or even cutting of wafers from an ingot with the help of lasers and etching media has not to date been considered yet.

On a large industrial scale, silicon wafers at present are produced practically exclusively with one method, multi-wire slurry sawing. The silicon blocks are thereby separated mechanically by abrasion by means of moving wires which are wetted with a grounding emulsion (e.g. PEG+SiC particles). Since the cutting wire which can be a few hundred kilometres long is wound many times around grooved wire guide rolls, many hundreds of wafers can be cut simultaneously with the resulting wire field.

In addition to the high material loss of approx. 50%, caused by the relatively wide cut notch, this method also has a further serious disadvantage. Because of the mechanical effect of the cutting wire and the abrasive materials during sawing, significant damage occurs here also in the crystalline structure at the surfaces of the cut semiconductor discs, which thereafter requires further chemical removal of material. Methods are likewise known from the state of the art in which laser light is applied for excitation of etching media both in gaseous and in liquid form over the substrate. Various materials serve here as etching media, e.g. potassium hydroxide solutions of various concentrations (by Gutfeld, R. J./Hodgson, R. T.: “Laser enhanced etching in KOH” in: Appl. Phys. Lett., Vol. 404, 352-354, 15 February (1982)) as far as liquid or gaseous halogenated hydrocarbons, in particular bromomethane, chloromethane or trifluoroiodomethane (Ehrlich, D. J./Osgood, R. M./Deutsch, T. F.: “Laser-induced microscopic etching of GaAs and InP” in: Appl. Phys. Lett., Vol. 36(8), 698-700, 15 April (1980)).

Further methods for machining solids, e.g. for microstructuring semiconductors in the production of chips or for side edge insulation in the case of solar cells, are described in the publications DE 36 432 84 A and WO 99/56907 A1 by the Company SYNOVA SA.

The removal of material is thereby effected either purely by ablation, purely chemically or both processes are combined together. The form of the removal is dependent upon the choice of laser parameters (intensity of the laser light, wavelength, pulse duration etc.) and the choice of liquid medium. In particular by using long pulse lasers, cut depths can be achieved today already of up to 2 cm and more even with purely aqueous media as liquid light conductors.

There is used as actual etching medium for the silicon in the case of the mentioned methods practically exclusively chlorine which is released however to date always from molecular compounds during radiation with energy-rich photons. Such chlorine sources are for example chlorinated hydrocarbons, e.g. tetrachlorocarbon, chlorine-sulphur compounds, such as for example disulphur dichloride (S₂Cl₂) and sulphuryl chloride (SO₂Cl₂) or chlorine-phosphorus compounds, such as for instance phosphorus trichloride (PCl₃) in which the chlorine is bonded covalently to further elements. Many of these compounds under standard conditions, in which they are used because of their rather low boiling points, have an extremely high chemical stability, as a result of which the use of radiation of a relatively short wavelength and high intensity is required in order to induce their quantitative splitting. This procedure however has the disadvantage that also non-intended bond breaks in the chlorine sources are thereby produced. The consequence then is the formation of a whole series of undesired by-products, such as for example silicon carbide, silicon sulphide, silicon dioxide etc., from which—entirely contrary to the desired main product SiCl₄ -silicon can scarcely be recovered economically.

A further problem with the chosen conditions is the forming of free chlorine gas in the light conductor which leads, by means of bubble formation, occasionally to a disturbance in the laminarity of the liquid jet, as a result of which the laser beam also experiences interruptions, which in turn results in an impairment in the quality of the cut notch.

In the mentioned methods, there were used as solvents inert, even halogen-rich and economical organic compounds with a small non-halogen component, for example tetrachlorocarbon. However, even these undergo reactions with the formed chlorine radical, as a result of which chlorine or hydrogen chloride gas and also alkyl radicals are formed, as in the case of tetrachloromethane, the trichloromethyl radical:

•Cl+CCl₄→Cl₂+•CCl₃

It was therefore the object of the present invention to ensure as efficient as possible removal of material from the solids to be machined with a significantly reduced formation of undesired by-products during the removal process. At the same time, it is the object of the present invention to reduce the free concentration of the active etching agent whilst maintaining the activity thereof and hence the same etching rate.

This object is achieved by the method having the features of claim 1. Claim 34 mentions a use according to the invention. The further dependent claims reveal advantageous developments.

### SUMMARY OF THE INVENTION

According to the invention a method is produced for removing material from solids by means of at least one laminar liquid jet comprising a mixture containing at least one at least partially fluorinated C₄-C₁₄ hydrocarbon which is liquid under standard conditions with respect to pressure and temperature and at least one photo- or thermochemically activatable halogen source.

The first component absorbs IR radiation poorly or in the ideal case not at all and, relative to blue light and radiation in the near UV range, is also relatively insensitive, i.e. inert, so that undesired degradation reactions of the first component do not occur.

With respect to the selection of the at least partially fluorinated hydrocarbon (C₄ to C₁₄), the following deciding factors are crucial:
a) Gas solubility
b) Reactivity relative to chlorine
c) Thermal and photochemical resistance
d) Combustibility and tendency to explode
e) Optical properties, i.e. as low as possible absorption of the laser light wavelengths which are used for thermal ablation of the silicon
f) Boiling point
g) Potential for environmental damage
h) Chemical costs

### a) Gas Fluid

With respect to the gas fluid, both aromatic and aliphatic compounds are possible. Aromatic compounds have, because of the expanded Pi electron system, the possibility of constructing a coordinate bond to the gas molecules dissolved therein.

b) Reaction with Chlorine

In this respect, it is important that the compounds used show no tendency to react with chlorine or the compounds hereof.

### c) Thermal and Photochemical Resistance

It is important here that, in the wave range chosen for the irradiation, merely the generation of elementary, possibly atomic chlorine from chlorine sources is effected. Any absorption of the solvent, i.e. of the partially fluorinated hydrocarbons reduces the photons available in the liquid jet for generating chlorine and hence the quantum yield during the excitation process.

### d) Combustibility and Tendency to Explode

In general, highly fluorinated or perfluorinated compounds are very inert and non-combustible under normal conditions, i.e. they show an exceptionally low tendency towards oxidation. This is caused by the high thermodynamic stability of the C—C and C—F-single bonds. π electrons in the molecule represent, in contrast, always a reactive centre, which has the consequence that perfluorinated aromatics, despite their high inertness, tend always to be more unstable relative to perfluorinated alkanes or ethers.

### e) Optical Properties

All usable, at least partially fluorinated, hydrocarbons must show low absorption in the wavelength range of the radiation source, in which the radiation is used exclusively for melting the silicon (at 1064 nm). Only in this way can a radiation loss in the liquid jet be avoided.

### f) Boiling Points

Any accumulation of material in the notch, whether it be now recondensed silicon particles or retained solvent, represents an impediment to the liquid jet in the notch which results in premature breaking up of the laminarity of the liquid jet and hence in a loss in the removal properties. For this reason, it is favourable for the cutting process if the solvent has a boiling point which is only slightly above the operating temperature during the process because hence rapid evaporation of the solvent from the cut notch is ensured after impinging on the substrate surface.

### g) Potential for Environmental Damage

All perfluorinated hydrocarbon compounds, both aliphatics and aromatics, are strong greenhouse gases because they are high absorbers of IR radiation above all in the medium and distant IR which are reflected back into the atmosphere from the earth as heat radiation. The fact that they have very long lifespans (in part several thousand years) in the stratosphere, because of their high chemical resistance, compounds matters here. Hydrofluoroethers represent here a good compromise between the requirement for a relatively high chemical resistance to chlorine and a faster biological degradability. Their greenhouse-damaging potential is between 10 and 100 times less than that of perfluorinated compounds, which can be attributed substantially to their lesser lifespan in the atmosphere.

### h) Cost of Chemicals

Fluorine is one of the most aggressive chemicals used in technology. Elementary fluorine is actually one of the strongest oxidants. Handling thereof is consequently very difficult, which drives up costs for synthesis of compounds involving fluorine. A second cost factor is its limited availability in comparison with chlorine, the nearest neighbour in the group of halogens. These cost factors apply to all fluorine-hydrocarbon compounds equally. Nevertheless, there are significant differences in price between the individual fluorinated hydrocarbons. These reside above all within the present production scope of the individual materials, which is orientated greatly to the present supply and sales of materials in the case of large industrial consumers. A certain correlation between price and complexity of synthesis also cannot be ignored.

For example the perfluorinated alkanes, tertiary amines and hydrofluoroethers are therefore already widely used commercially nowadays, for instance as replacements for ozone-damaging CFCs, e.g. as propellants for synthetic materials, coolants for high-power computers, coolants for refrigerators, solvents in sprays etc.

Preferred, at least partially fluorinated hydrocarbons which can be used in the method according to the invention can be classified as follows.
1.) perfluorinated chain-shaped or branched alkanes, cycloalkanes or aromatics, e.g. perfluorobutane, perfluorocyclobutane, perfluoropentane, perfluorocyclopentane, perfluorohexane, perfluorocyclohexane, perfluoroheptane, hexafluorobenzene, perfluoro-n-hexane, perfluoro-n-heptane and also mixtures hereof.
2.) some compounds from the series of hydrofluoroethers (HFE), above all methoxyheptafluoropropane CH₃—O—C₃F₇, methylnonafluorobutylether CF₃—(CF₂)₃—O—CH₃ and methylnonafluoroisobutylether (CF₃)₂—CF—CF₂-O-CH₃, ethylnonafluorobutylether CF₃—(CF₂)₃—O—C₂H₅ and ethylnonafluoroisobutylether (CF₃)₂—CF—CF₂—O—C₂H₅ and 2-trifluoromethyl-3-ethoxydodecafluorohexane C₃F₇CF(OC₂H₅)CF—CF(CF₃)₂
3.) perfluorinated, tertiary amines, preferably perfluorotri-n-butylamine [CF₃(CF₂)₃]₃N and perfluorotri-n-pentylamine N(C₅F₁₁)₃

Preferably, the hydrocarbon is a linear or branched C₄-C₁₄ alkane, cycloalkane or an aromatic, which are particularly preferably perfluorinated. There are mentioned here merely by way of example perfluorobutane, perfluorocyclobutane, perfluoropentane, perfluorocyclopentane, perfluorohexane, perfluorocyclohexane, perfluoroheptane, hexafluorobenzene or mixtures hereof.

Relative to the mentioned laser-chemical removal methods, the present invention uses the numerous advantages of the solvent hexofluorobenzene (C₆F₆) which, relative to the solvents previously used in the process, has the following advantages:
1. C₆F₆ has a much smaller risk potential then previously used solvents, for instance tetrachloromethane (CCl₄). At present, it is not classified as a hazardous material according to MERCK.
2. C₆F₆ is significantly more inert relative to halogen radicals than other solvents; in the period of time relevant for the process in which the halogen radical, from the time of its generation until impingement on the surface to be etched, dwells in the liquid jet, C₆F₆ is practically completely resistant to a chemical attack by the radical.
3. The tendency of the hexafluorobenzene molecule to decompose is extremely low based on the aromatic character of the C₆ ring and the particular thermodynamic stability of the C—F bond which actually counts as the most stable of covalent bonds.
4. C₆F₆ “conserves” reactive molecules in the excited state by a multiple longer than other possible solvents, for instance CCl₄. In the system already comprehensively examined today, hexafluorobenzene-oxygen, excited singlet oxygen (¹Δ_{g}) has for instance a 1,000 times longer lifespan (approx. 25 milliseconds) than in CCl₄ (approx. 25-35 microseconds). The same is also applicable for the system hexafluorobenzene-chlorine.
5. Hexafluorobenzene is an excellent host molecule for many uncharged, low-molecular compounds with a low-molecular weight, for instance oxygen and water but also chlorine and hydrogen chloride. As is already known today, similar to the haemoglobin in blood, it has the capacity to bond O₂ molecules coordinately and, in this way, to transport them over wide distances in the blood circulation, preventing the formation of bubbles by gas evolution of the bonded molecules which would be lethal for the human organism. On the basis of this property, C₆F₆ is already used today in medicine in order to transport oxygen in tumour cells and there to excite them photochemically. C₆F₆ is an ideal transporter for loosely bonded gas which is easily accessible therefore for chemical processes in liquid medium.

The choice of hexafluorobenzene as liquid light conductor hence enables direct use of elementary chlorine or hydrogen chloride gas, the actual etching media during the process, without a risk of bubble formation and a thus associated impairment in the cut quality thereby being expected. This step is made possible only by the special transport properties of the C₆F₆ molecule. A way round an in situ formation of chlorine by splitting from non-gaseous compounds which are in part extremely stable thermodynamically is no longer absolutely necessary. Hence also the demands made on the light sources to be used for the photochemical activation of the etching medium are hence reduced.

Elementary chlorine gas which is bonded purely coordinately to C₆F₆ molecules can even be activated with blue light. In this frequency range the solvent C₆F₆ is absolutely stable; no decomposition and thus associated formation of undesired by-products results, as would be expected when using shorter wave radiation with high intensities for splitting covalently bonded chlorine.

Furthermore, C₆F₆ as solvent ensures a particularly long lifespan of the excited halogen molecules, as a result of which for example a multiple activation of one and the same chlorine molecule or radical during its stay in the liquid jet is also no longer required.

The use of hexafluorobenzene as solvent hence also confers a reaction-kinetic advantage relevant to other solvents.

The laser-chemical etching process has previously comprised the following partial processes:
1. release of the chlorine from the chlorine source by breaking a chemical bond,
2. photochemical activation of the chlorine by irradiation with shortwave electromagnetic radiation (UV light). If the lifespan of the excited state is very short, then—as already indicated—multiple activation must be effected within the timespan in which the chlorine is present in the liquid jet because of permanent relaxation. This is a very energy-intensive—and correspondingly high energy-loss—process.
3. ablative removal and, in parallel thereto, melt of the silicon to be etched.
4. reaction of excited chlorine with silicon melt and gaseous silicon or hot Si microparticles centrifuged out of the etching furnace.
5. transport away of gaseous etching products, partly dissolved in the solvent.

For all these partial processes together, there is a time interval available, the size of which should be established temporally in the sub-millisecond range. Since the individual partial processes are built directly one upon the other, even slight irregularities can cause the chain process to come to a standstill. It is correspondingly beneficial—above all for the yield of etching products during the entire process—if part of these individual steps can be eliminated.

Due to the possibility of the direct use of chlorine or hydrogen chloride, step 1—the generation of chlorine from molecular compounds—is eliminated.

The high lifespan of excited states of molecules in hexafluorobenzene makes it possible—as already indicated—to eliminate multiple excitation of the chlorine and hence to reduce the time requirement for step 2.

The second component is preferably a halogen source and/or hydrogen halide which can be activated by irradiation. This component can be excited by irradiation, for example by blue or UV light, or split into radicals.

Preferably, the halogen source is selected from the group consisting of water-free, halogen-containing organic or inorganic compounds and mixtures thereof. There are included herein for example fluorinated, chlorinated, brominated or iodated hydrocarbons, the hydrocarbons being straight-chain, branched, aliphatic, cycloaliphatic and/or aromatic Cl-C₁₂ hydrocarbons. Particularly preferred representatives are tetrachlorocarbon, chloroform, bromoform, dichloromethane, dichloroacetic acid, acetylchloride and/or mixtures hereof.

A further preferred variant provides that the second component contains in addition elementary halogens, in particular chlorine, or hydrogen halides, in particular hydrogen chloride. Interhalogen compounds are also used.

Examples of activation reactions according to the method according to invention are:

IC1→I•+Cl• iodine radical chlorine radical

CH₂Cl₂→•CH₂Cl+Cl• methylenechloride radical

If for example a silicon solid is etched, then the following reaction underlying that of the etching effect is:

4 Cl•+Si→SiCl₄

The etching effect is effected practically non-selectively with respect to specific crystal orientations. Recombination of radicals frequently leads to likewise very reactive substances which can remove silicon directly at a high etching rate. This reaction is effected corresponding to the subsequent equations:

2Cl•→Cl₂

2Cl₂+Si SiCl₄

These facts and also the existence of a radical-chain reaction ensure a continuous and relatively constant high removal of the silicon.

Furthermore, it can be advantageous if the halogen source is selected from the group of halogen-containing sulphur and/or phosphorus compounds. There are included herein in particular sulphuryl chloride, thionyl chloride, sulphur dichloride, disulphur dichloride, phosphorus trichloride, phosphorus pentachloride., phosphoryl chloride and mixtures thereof.

A further preferred variant of the method according to the invention provides that the mixture contains in addition a strong Lewis acid, such as e.g. boron trichloride and aluminium trichloride. Due to these supplements, the decomposition tendency of the etching media under specific conditions, e.g. for sulphuryl chloride and thionyl chloride, can be increased and hence the reactivity of the etching medium increased.

In order that the radiated radiation energy can be used effectively, it is preferred to add radiation absorbers in addition to the mixture, which radiation absorbers absorb in part the radiated electromagnetic radiation and consequently are excited. When returning into the basic state, the released energy is emitted to the halogen source or to the solid to be machined, which for their part consequently are activated or excited and hence become more reactive. The spectrum of the activation or excitation form ranges hereby from a purely thermal as far as a purely chemical (electron transfer) excitation. There are used as radiation absorbers preferably colourants, in particular eosin, fluorescein, phenolphthalein, Bengal pink as adsorbers in the visible range of light. There are used as UV absorbers preferably polycyclic aromatic compounds, e.g. pyrene and naphthacene. In addition to an increase in the effective use of the radiated energy, by means of the radiation absorbers also a wider spectrum of usable radiation for the method according to the invention is provided.

The activation of the halogen source can be effected also by a radical route by addition of radical starters, e.g. dibenzoyl peroxide or azoisobutyronitrile (AIBN) which are added to the second component.

The direct introduction of hydrogen chloride gas as halogen source into the liquid medium directly before the etching process has the advantage that the etching medium is already present directly in the solution without firstly requiring to be generated by bond breakage. In addition, this variant reduces the number of possible contaminations for the silicon in the process. In particular phosphorus and sulphur are frequently undesired as potential dopants for silicon.

Chlorine- or hydrogen chloride gas can be bonded coordinately by hexafluorobenzene, as a result of which their gas evolution is prevented. The coordinate bond (complex bond) is a comparatively weak chemical bond which can be broken even with a small supply of energy, differently from a covalent bond in molecules, for the splitting of which usually shortwave UV light is required, as is evident from the following reaction equations.

SCl₂+hv→•SCl+Cl• (λ≈300 nm)

S₂Cl₂+hv→S₂+2Cl• (λ<277 nm)

CCl₄+hv→•CCl₃+Cl• (λ≈257 nm, 185 nm)

in contrast

Cl₂+hv→2Cl• (λ>400 nm)

(“•” symbolises an unpaired electron; all species marked with “•” are accordingly radicals). Furthermore, it is advantageous if there is added to the mixture at least one further substance, selected from the group of at least partially fluorinated alkanes, preferably 1,1,1,2,3,4,4,5,5,5-decafluoropentane. The mixture can contain in a particularly preferred manner pure hexafluorobenzene or a mixture of hexafluorobenzene and 1,1,1,2,3,4,4,5,5,5-decafluoropentane which has a similar chemical stability and passivity relative to halogens as the aromatic compound saturated with fluorine. The boiling point of the hexafluorobenzene under standard conditions is at approx. 80-82° C., whilst decafluoropentane boils already at approx. 55° C. and does not have the special gas storage properties of hexafluorobenzene which is somewhat disadvantageous for the process. The great advantage of decafluoropentane is however its more favourable price which at present is only approx. 1/10 of the market price of hexafluorobenzene and therefore it is relatively well suited as diluting agent for C₆F₆.

In a preferred embodiment, the activation is hereby effected by irradiation. There is hereby understood as irradiation in the sense according to the invention all forms of supplying energy in the form of electromagnetic waves.

There serve for activation according to the chosen etching medium, all ranges of the electromagnetic spectrum, from the infrared range to the UV range, thermochemical activation being effected predominantly in the IR range but not exclusively, photochemical activation in contrast predominantly in the visible and in the UV range but not exclusively.

Activation can be effected both with incoherent and with coherent light. A wide palette of radiation sources which can be used according to the invention is hence available. Consequently, favourable and simple light sources, such as for example a mercury arc lamp, photodiode and/or a flashlight lamp can be used. Of course, also lasers are however suitable for implementing the etching process according to the invention.

The irradiation can be effected both continuously and pulsed. In the case of the pulsed method, it is particularly advantageous that the quantity of activated species of the etching medium generated in the beam can be effectively controlled.

In order to increase the etching effect further, also a plurality of liquid jets can be guided adjacently in parallel as an advantageous embodiment. Hence a significant shortening of the machining time of the solid can be achieved. In addition, when surrounding each individual jet with its own radiation source, a specific redundancy results so that the failure of an individual radiation source can be well compensated for.

In addition, also to assist the material removal, a laser beam can be coupled in parallel into the liquid jet. There is understood by parallel in the sense according to the invention that the laser beam extends approximately coaxially in the liquid jet. The laser is thereby advantageously an IR laser.

The method according to the invention is entirely suitable in particular for removing material from silicon solids. These can be amorphous, poly- or monocrystalline. Preferably, silicon wafers are treated therewith. The method according to the invention can however also be applied to any solids as long as the chemical system used displays a similar etching effect.

The present method enables rapid, simple and economical machining of solids, in particular made of silicon, e.g. microstructuring, cutting, doping of solids and/or local deposition of foreign elements on solids, in particular the cutting of silicon blocks into individual wafers. The structuring step thereby introduces no crystal damage into the solid material so that the solids or cut wafers require no wet chemical damage etch which is normal for the state of the art. In addition, the previously occurring cut waste is recycled via a connected recycling device so that the total cut loss can be reduced drastically, in particular when cutting wafers (e.g. by 90%). This has an immediately minimising effect on the production costs of the silicon components machined in this way, such as e.g. on the still relatively high production costs for solar cells.

The method for metallisation of solids, in particular silicon wafers, can likewise be applied.

With reference to the subsequent Figure and examples, the method according to the invention is described in more detail without intending to restrict it hereto.

The apparatus used, precisely like systems based on liquid jet-guided lasers in the state of the art, has the following essential components:
1.) a laser source 1, generally a long pulse laser or a high-power short pulse laser, with a wavelength in the infrared range which serves for removal of silicon by ablation; the laser is generally located spatially removed from the remaining part of the apparatus, therefore guidance of the laser light 1a towards the apparatus is effected predominantly via a glass fibre; however also beam guidance via a free space optic is conceivable.
2.) a shortwave light source 2, e.g. a mercury arc lamp or a photocell, which is disposed directly below the coupling unit annularly about the liquid jet and serves for chemical activation of the etching medium.
3.) a powerful pump 3 for liquid media which is required to produce a liquid jet with a high flow rate;
4.) a machining device 4, e.g. chuck, on which the workpiece 5 is fixed for example by suction;
5.) x-, y-, z-table on which the machining device is located and can be moved in three spatial directions; alternatively the liquid jet can also be moved;
6.) a reaction chamber 6 which houses the machining device and hence enables use of hazardous substances as etching media;
7.) a special nozzle which produces a laminar liquid jet;
8.) an optical system 8 which focuses the laser light 1a emerging from the glass fibre or directly from the laser and couples it then into the laminar liquid jet which serves then as liquid light conductor. Occasionally, also a beam formation of the laser beam takes place at this point with respect to the light intensity distribution in the laser spot.
9.) the system has in addition a chemical supply unit 9 with at least two tanks in which the medium required to produce the liquid jet is stored in the interim and in which a separation of the etching products from the solvent is effected by distillation.

During the process, the halogen source is generated by irradiation with a flashlight or Hg vapour lamp on the stretch between coupling unit and silicon surface. The silicon is removed for the large part by ablation by the IR laser and leaves the bulk surface either in gaseous form or in a bundle in microparticles with a large active surface. In the liquid jet, it impinges in this form on excited halogen molecules or radicals with which it reacts to form tetrachlorosilane or trichlorosilane, both gaseous products which can be removed easily from the etching furnace and distilled off finally from the higher boiling point solvents. Finally, from them, analogously to the large-scale industrial process for preparing ultrapure silicon for the semiconductor industry, highly pure silicon can be obtained.

### EXAMPLE 1

A perfluorinated alkane, for instance perfluoro-n-hexane (C₆F₁₄), serves thereby as solvent. Into the latter, dry chlorine gas is introduced which has therein an approx. 10 times higher gas solubility than in water and an at least 3 times higher gas solubility than perchlorinated or highly chlorinated hydrocarbons which can serve potentially as an option for the perfluoro compounds, such as for instance CCl₄ or CHCl₃. For this reason, even when doubling the chlorine gas concentration relative to aqueous media, no gas evolution of the halogen should be expected, as a result of which the laminarity of the jet would be endangered. Relative to the chlorinated compounds, C₆F₁₄ has the advantage of absence of toxicity and an ozone-damaging effect. The introduced chlorine gas concentration is for example between 5 and 10% by weight.

A laser beam of the wavelength of 1064 nm is coupled into the liquid jet and serves for the purpose of melting silicon on the substrate surface. The laser which is used is for example an Nd: YAG laser with an average laser power of 100 watt and a pulse length of approx. 150600 nm. At the wavelength of 1064 nm, the absorption of the perfluorinated alkane and the chlorine dissolved therein is negligibly low, for instance by a power of ten less than in water.

The chlorine dissolved in the liquid jet undergoes practically no reaction with silicon at temperatures below 300° C.; on molten silicon, the reaction with chlorine is actually one of the fastest known surface reactions and delivers an extremely large amount of energy which is emitted in the form of heat into the environment. Approx. 662 kJ of energy is released per mol of formed SiCl₄, the main product of the etching reaction; this is more energy than is formed during the reaction between two mol hydrogen- and one mol oxygen molecules within the scope of the hydrogen-oxygen reaction. Although perfluorinated hydrocarbons belong to the chemically and thermally resistant liquids, not all molecules of the solvent will cope with this quantity of energy. A part thereof is decomposed in the hot etching furnace. This process has the result on the one hand, that a part of the expensive solvent is irretrievably lost thereby. This process does however also have a substantial advantage at the same time: the fragmented molecule fragments are integrated during the cooling process into the solidifying silicon surface. A dense layer of perfluorinated carbon chains which are bonded covalently to terminal silicon atoms and which ensure excellent gas absorption (gas solubility) on the silicon surface are produced, as is the case with the solvent itself. The better the gas absorption on the substrate surface, the higher are the chances of good texturing of the same. Because of the extremely high bonding energy of the C—F bond which represents one of the most stable covalent bonds in organic chemistry, the deposition of elementary carbon as waste product of the decomposition process of the solvent should not be expected; instead, unsaturated carbon-fluorine compounds are produced, such as for instance tetrafluoroethene C₂F₄ which are all gaseous and do not cause impairment in the cut notch due to the solvent flow.

### EXAMPLE 2

There serves here as solvent a mixture of methylnonafluorobutylether and methylnonafluoroisobutylether into which chlorine gas is introduced. The gas solubility therein is comparable to that in perfluoroalkanenes; for this reason, also corresponding gas concentrations in the jet can be chosen.

The solvent has, differently from the perfluorinated alkanes, a non-halogenated hydrocarbon radical which can be attacked by the chlorine gas which is introduced, as a result of which the concentration of free chlorine gas in the liquid jet is reduced. Since this reaction is light- or heat-induced, the solvent enriched with chlorine must be stored in the dark and away from heat sources. If this is the case, then the chlorine-containing solution can be stored for several days without significant loss of chlorine.

Remaining test parameters can turn out as in example 1.

What is claimed is:

1. A method for removing material from solids by means of at least one laminar liquid jet comprising a mixture containing at least one at least partially fluorinated hydrocarbon (C₄-C₁₄) and at least one photo- or thermochemically activatable halogen source.

2. The method according to claim 1, wherein the hydrocarbon is a linear or branched alkane, cycloalkane or an aromatic.

3. The method according to claim 1, wherein the hydrocarbon is perfluorinated.

4. The method according to claim 3, wherein the hydrocarbon is selected from the group consisting of perfluorobutane, perfluorocyclobutane, perfluoropentane, perfluorocyclopentane, perfluorohexane, perfluorocyclohexane, perfluoroheptane and mixtures hereof.

5. The method according to claim 1, wherein the hydrocarbon is hexafluorobenzene.

6. The method according to claim 1, wherein the hydrocarbon is selected from the group of hydrofluoroethers, in particular methoxyheptafluoropropane CH₃—O—C₃F₇, methylnonafluorobutylether CF₃ —(CF₂)₃—O—CH₃ and methylnonafluoroisobutylether (CF₃)₂—CF—CF₂—O—CH₃, ethylnonafluorobutylether CF₃—(CF₂)₃—O—C₂H₅ and ethylnonafluoroisobutylether (CF₃)₂—CF—CF₂—O—C₂H₅ and also 2-trifluoromethyl-3-ethoxydodecafluorohexane C₃F₇CF(OC₂H₅)CF—CF(CF₃)₂.

7. The method according to claim 1, wherein the hydrocarbon is a perfluorinated, tertiary amine, in particular perfluorotri-n-butylamine [CF₃(CF₂)₃]₃N and perfluorotri-n pentylamine N(C₅F₁₁)₃.

8. The method according to claim 1, wherein the halogen source is selected from the group consisting of elementary halogens, and also water-free, halogen-containing organic or inorganic compounds and mixtures thereof.

9. The method according to claim 8, wherein the halogen source is selected from the group consisting of tetrachlorocarbon, chloroform, bromoform, dichlioromethane and mixtures hereof.

10. The method according to claim 1, wherein the halogen source is selected from the group of halogen-containing sulphur and/or phosphorus compounds.

11. The method according to claim 10, wherein the halogen source is selected from the group consisting of sulphuryl chloride, thionyl chloride, sulphur dichloride, disulphur dichioride, phosphorus trichloride, phosphorus pentachloride, phosphoryl chloride and mixtures thereof.

12. The method according to claim 1, wherein chlorine and/or hydrogen chloride is used as halogen source.

13. The method according to claim 1, wherein the mixture contains in addition Lewis acids, in particular boron trichioride or aluminium trichloride.

14. The method according to claim 1, wherein the mixture contains in addition at least one radical starter.

15. The method according to claim 14, wherein the radical starter is selected from the group consisting of dibenzoyl peroxide and azoisobutyronitrile.

16. The method according to claim 1, wherein the mixture contains in addition at least one radiation absorber.

17. The method according to claim 16, wherein the radiation absorber is a colourant, in particular eosin, fluorescein, phenolphthalein and/or Bengal pink.

18. The method according to claim 16, wherein the radiation absorber is a polycyclic aromatic compound, in particular pyrene or naphthacene.

19. The method according to claim 1, wherein the mixture in addition contains at least one further compound, selected from the group of at least partially fluorinated alkanes, in particular 1,1,1,2,3,4,4,5,5,5 decafluoropentane.

20. The method according to claim 1, wherein the activation is effected before impingement of the liquid jet on the solid.

21. The method according to claim 1, wherein the activation is effected by irradiation.

22. The method according to claim 20, wherein the irradiation is effected in the UV range of the electromagnetic spectrum and as a result a substantially thermochemical activation of the etching medium is effected.

23. The method according to claim 20, wherein the irradiation is effected in the JR range of the electromagnetic spectrum and as a result a substantially thermochemical activation of the etching medium is effected.

24. The method according to claims 20, wherein the irradiation is effected in the visible range of the electromagnetic spectrum and as a result a substantially photochemical activation is effected.

25. The method according to of the claims 20, wherein an irradiation with incoherent light is effected.

26. The method according to of the claim 20, wherein an irradiation with coherent light, preferably laser light, is effected.

27. The method according to one of the claim 20, wherein the irradiation is effected continuously.

28. The method according to claim 20, wherein the irradiation is effected pulsed.

29. The method according to claim 20, wherein the irradiation is effected via a UV light source, preferably a mercury arc lamp, photodiode, flashlight lamp and/or laser.

30. The method according to claim 1, wherein a plurality of liquid jets is guided in parallel.

31. The method according to claim 1, wherein, in order to assist the material removal, in addition a laser is coupled in parallel into the liquid jet.

32. The method according to claim 31, wherein the laser emits light which is in the infrared range of the electromagnetic spectrum.

33. The method according to claim 1, wherein a body made of silicon is used.

34. A use of the method according to claim 1 for cutting, microstructuring, doping of solids and! or local deposition of foreign elements on solids, in particular of silicon wafers.
